(19) United States
(12) Patent Application Publication
(10) Pub. No.: US 2008/0186543 A1
(43) Pub. Date: Aug. 7, 2008

(54) IMAGE FORMING APPARATUS AND IMAGE FORMING METHOD

(75) Inventor: Makoto Harigae, Shinagawa-ku (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/670,693

(22) Filed: Feb. 2, 2007

(51) Int. Cl. G06K 15/02

(52) U.S. Cl. 358/3.24

(57) ABSTRACT

There is provided a technique in which in an image forming apparatus capable of executing both monochrome printing and color printing, the work efficiency of an image forming processing can be improved.

There are included a first setting information acquisition unit to acquire setting information relating to a print setting of monochrome printing, a second setting information acquisition unit to acquire setting information relating to a print setting of color printing, and a print execution unit to cause the monochrome printing based on the setting information acquired by the first setting information acquisition unit and the color printing based on the setting information acquired by the second setting information acquisition unit to be successively executed.

### BACKGROUND OF THE INVENTION

1. Field of the Invention

The present invention relates to an image forming apparatus capable of executing both monochrome printing and color printing, and particularly to an improvement in efficiency of an image forming processing.

2. Description of the Related Art

Hitherto, there is known an image forming apparatus capable of executing both monochrome printing to print a monochrome image on a sheet and color printing to print a color image on a sheet.

FIG. 4 is a view for explaining a rough structure of an image forming apparatus 9 of the related art, and FIG. 5 is a view showing an example of a display screen in a control panel 908 of the image forming apparatus 9 of the related art.

In general, since monochrome printing and color printing can not be performed at the same time in an image forming apparatus, in the case where both the monochrome printing and the color printing are desired to be performed based on the same original document in the image forming apparatus of the related art, first, a print setting for the monochrome printing is performed to execute the monochrome printing, and after the monochrome printing is completed, a print setting for the color printing is performed to execute the color printing. As is understood from the screen display example shown in FIG. 5, in the control panel of the image forming apparatus of the related art, the display form is such that only one of the monochrome printing and the color printing can be set.

As stated above, in the image forming apparatus of the related art, even if the print processing is based on the same original document, in the case where the print color varies, the duplicate operations must be performed, and it has not been preferable in view of the work efficiency.

Besides, in the case where both the monochrome printing and the color printing are performed, the print setting for either one of them is performed, and until the print processing based on the print setting is completed, the print setting for the other can not be performed, and therefore, the user can not leave the apparatus for a long time, and this has been inconvenient.

Besides, even in the case where a similar print setting is desired to be performed for the monochrome printing and the color printing, the setting operation must be performed individually, and there has been a fear that a setting miss occurs.

### SUMMARY OF THE INVENTION

An embodiment of the invention has an object to provide a technique in which in an image forming apparatus capable of executing both monochrome printing and color printing, the work efficiency of an image forming processing can be improved.

In order to solve the problem, an image forming apparatus according to an aspect of the invention includes a first setting information acquisition unit configured to acquire setting information relating to a print setting of monochrome printing, a second setting information acquisition unit configured to acquire setting information relating to a print setting of color printing, and a print execution unit configured to cause the monochrome printing based on the setting information acquired by the first setting information acquisition unit and the color printing based on the setting information acquired by the second setting information acquisition unit to be successively executed.

Besides, an image forming apparatus according to another aspect of the invention includes first setting information acquisition means for acquiring setting information relating to a print setting of monochrome printing, second setting information acquisition means for acquiring setting information relating to a print setting of color printing, and print execution means for causing the monochrome printing based on the setting information acquired by the first setting information acquisition means and the color printing based on the setting information acquired by the second setting information acquisition means to be successively executed.

Besides, an image forming method according to another aspect of the invention includes steps of acquiring first setting information relating to a print setting of monochrome printing, acquiring second setting information relating to a print setting of color printing, and causing the monochrome printing based on the setting information acquired at the step of acquiring the first setting information and the color printing based on the setting information acquired at the step of acquiring the second setting information to be successively executed.

### DESCRIPTION OF THE DRAWINGS

FIG. 1 is a functional block diagram for explaining an image forming apparatus according to an embodiment of the invention.

FIG. 2 is a view showing a screen display example in a display unit 107 (control panel) of an image forming apparatus 1 according to this embodiment.

FIG. 3 is a flowchart for explaining a rough flow of a processing (image forming method) in the image forming apparatus 1 according to this embodiment.

FIG. 4 is a view for explaining a rough structure of an image forming apparatus of the related art.

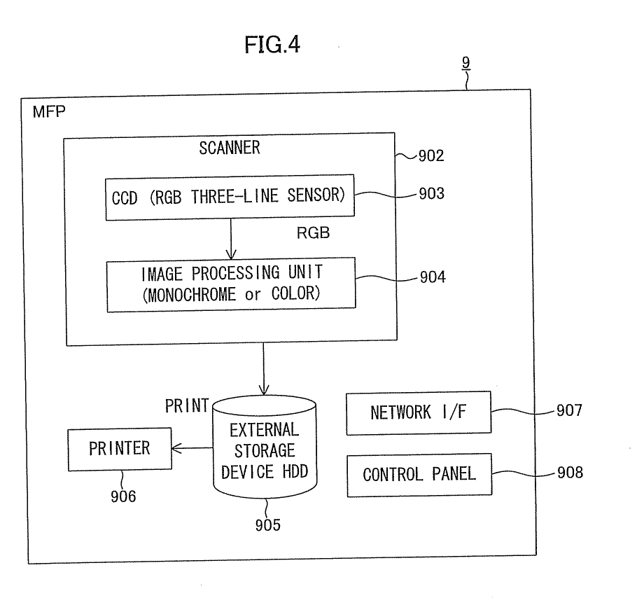

FIG. 5 is a view showing an example of a screen display in a control panel of the image forming apparatus of the related art.

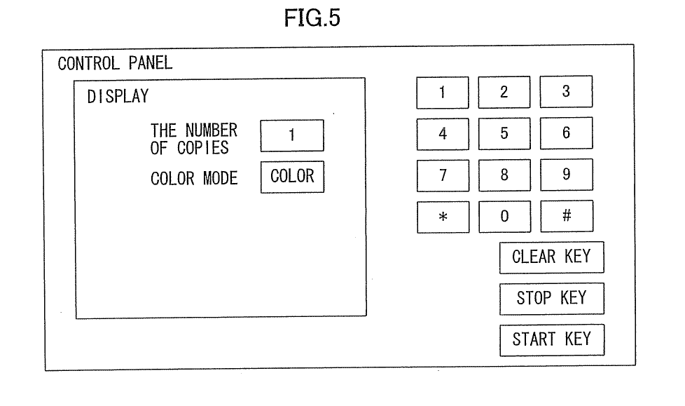

### DESCRIPTION OF THE EMBODIMENTS

Hereinafter, embodiments of the invention will be described with reference to the drawings.

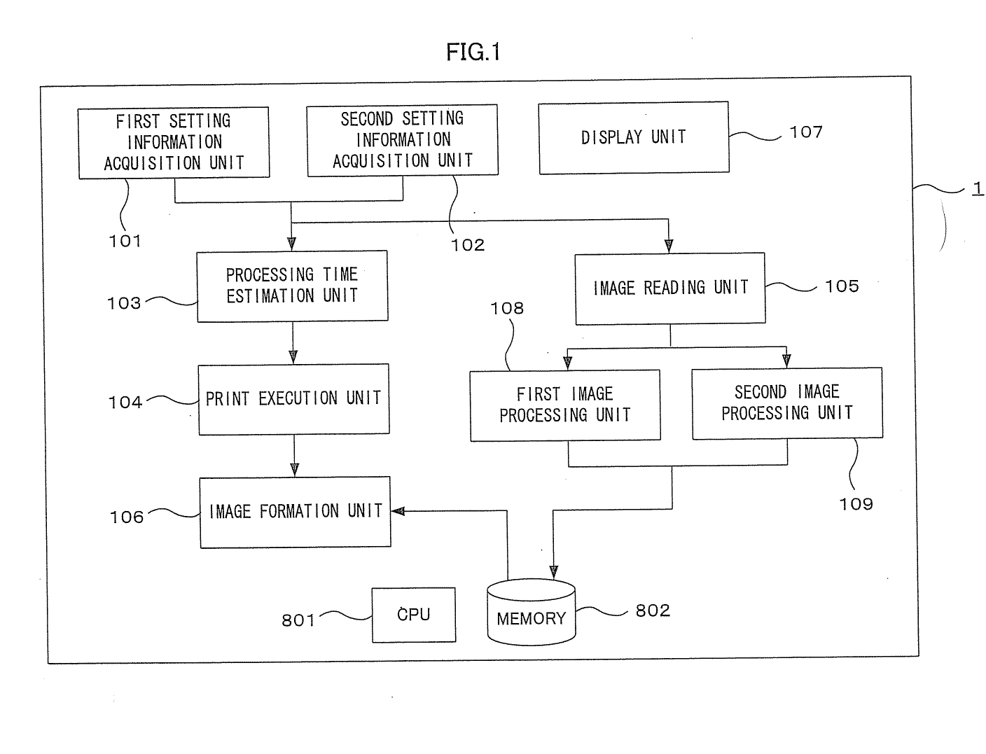

FIG. 1 is a functional block diagram for explaining an image forming apparatus according to an embodiment. The image forming apparatus 1 according to this embodiment is, for example, an MFP (Multi Function Peripheral), and includes a first setting information acquisition unit 101, a second setting information acquisition unit 102, a processing time estimation unit 103, a print execution unit 104, an image reading unit 105, an image formation unit 106, a display unit 107, a first image processing unit 108, a second image processing unit 109, a CPU 801 and a MEMORY 802.

The first setting information acquisition unit 101 acquires setting information relating to a print setting of monochrome printing.

The second setting information acquisition unit 102 acquires setting information relating to a print setting of color printing.

Here, the setting information relating to the print setting includes, for example, “the number of prints”, “enlargement magnification”, “reduction magnification”, “margin setting”, “density setting”, “gradation setting”, “resolution setting”, “double-sided or single-sided setting”, “sort setting”, “staple position setting” and “punch hole position setting”.

The processing time estimation unit 103 estimates a time required for a preparation processing performed for the monochrome printing based on the setting information acquired by the first setting information acquisition unit 101 and a time required for a preparation processing performed for the color printing based on the setting information acquired by the second setting information acquisition unit 102. Specifically, as the preparation processing performed for the printing, for example, there can be mentioned an image processing for creating data for printing. Incidentally, the estimation processing of the processing time in the processing time estimation unit 103 is calculated based on, for example, the acquired print setting and a previously prepared arithmetic expression or data table. Of course, in order to more accurately estimate the processing time, an inquiry about the present processing state and processing load state may be made to the first image processing unit 108 and the second image processing unit 109 (the details will be described later).

The print execution unit 104 causes the monochrome printing based on the setting information acquired by the first setting information acquisition unit 101 and the color printing based on the setting information acquired by the second setting information acquisition unit 102 to be successively executed.

As stated above, the print settings of the monochrome printing and the color printing are collectively acquired, and the print processings based on these print settings are successively continuously performed at a time, and therefore, the user can execute both the monochrome printing and the color printing by merely performing the print settings of the monochrome printing and the color printing collectively at a time. By this, unlike the image forming apparatus of the related art, in the case where both the monochrome printing and the color printing are desired to be performed based on the same image, it becomes unnecessary to again perform the print setting for the color printing after completion of the monochrome printing, and a contribution can be made to the improvement of work efficiency.

Incidentally, it is desirable that the print execution unit 104 causes the monochrome printing and the color printing to be successively executed from one of them in which the time estimated by the processing time estimation unit 103 is shorter.

In general, in the image forming apparatus capable of executing both the monochrome printing and the color printing, the monochrome printing and the color printing can not be performed at the same time, and it is necessary to perform them in order. Thus, between the monochrome printing and the color printing, one in which the preparation processing, such as image processing, performed for execution of printing is completed earlier is first executed, so that a wasteful waiting time does not occur in the image forming apparatus, and a contribution can be made to the improvement of the working ratio of the image forming apparatus.

Besides, the print execution unit 104 can cause the monochrome printing based on the setting information acquired by the first setting information acquisition unit 101 to be executed earlier than the color printing based on the setting information acquired by the second setting information acquisition unit 102.

In general, as compared with the color printing, the amount of data handled in the monochrome printing is small, and the time required for the image processing is short, and therefore, it is efficient to cause the monochrome printing in which the image processing is completed earlier than the image processing for the color printing to be executed first.

Besides, the print execution unit 104 can also cause the monochrome printing to be executed earlier than the color printing when the setting resolution acquired by the second setting information acquisition unit 102 is higher than the setting resolution acquired by the first setting information acquisition unit 101.

Specifically, for example, there can be mentioned a case where the setting resolution of the monochrome printing is “200 dpi”, and the setting resolution of the color printing is “300 dpi”. In such a case, the load of the image processing performed for the execution of the color printing is remarkably higher than the load of the image processing performed for the execution of the monochrome printing, and much time is taken for the processing. Thus, when the monochrome printing is executed while the image processing for the color printing is performed, the apparatus is not wastefully made to wait, and a contribution can be made to the improvement of the working ratio of the image forming apparatus.

In addition to this, when the setting gradation number acquired by the second setting information acquisition unit 102 is larger than the setting gradation number acquired by the first setting information acquisition unit 101, the print execution unit 104 may cause the monochrome printing to be executed earlier than the color printing.

Specifically, there can be mentioned a case where for example, the setting gradation number of the monochrome printing is “monochrome binary value”, and the setting gradation number of the color printing is “256 gradations”. In such a case, the load of the image processing performed for the execution of the color printing is remarkably larger than the load of the image processing performed for the execution of the monochrome printing, and much time is taken for the processing. Thus, from the same reason as the above, it is efficient to execute the monochrome printing while the image processing for the color printing is performed.

The image reading unit 105 has a role to optically read the reading surface of an original document placed on an original document stand or an original document automatically transported by an ADF (Auto Document Feeder). Here, it is assumed that the image reading unit 105 is a four-line sensor including three line sensors (for example, 300 dpi) capable of reading an image in RGB color, and one line sensor (for example, 600 dpi) capable of reading an image in monochrome.

The image formation unit 106 can perform the monochrome printing and the color printing, and performs the monochrome printing or the color printing based on the instruction from the print execution unit 104.

The display unit 107 includes, for example, a touch panel display (control panel), and has a role to screen-display processing contents in the image forming apparatus 1.

The first image processing unit 108 has a role to perform the image processing for execution of the monochrome printing, and the second image processing unit 109 has a role to perform the image processing for execution of the color printing.

The CPU 801 has a role to perform various processings in the image forming apparatus, and also has a role to realize various functions by executing a program stored in the MEMORY 802. The MEMORY 802 includes, for example, a ROM and a RAM, and has a role to store various information and programs used in the image forming apparatus.

Incidentally, the monochrome printing in this embodiment means printing of a monochrome image based on an image read from an original document by the image reading unit 105, or printing of a monochrome image based on image data transmitted from an external equipment connected to be capable of communicating with the image forming apparatus 1. Similarly, the color printing in this embodiment means printing of a color image based on an image read from an original document by the image reading unit 105 or printing of a color image based on image data transmitted from an external equipment connected to be capable of communicating with the image forming apparatus 1.

Hereinafter, the details of the operation in the image forming apparatus 1 according to this embodiment will be described. Here, mainly the print processing (copy processing) based on image data read from an original document by the image reading unit 105 will be described.

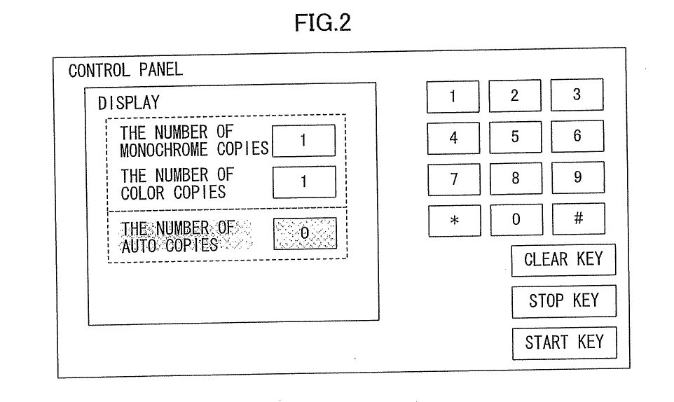

FIG. 2 is a view showing a screen display example in the display unit 107 (control panel) of the image forming apparatus 1 according to this embodiment.

As shown in the drawing, a “display”, a “numeric keyboard” a “clear key”, a “stop key” to stop copying, a “start key” to start a print processing and the like are screen-displayed on the display unit 107. Here, it is assumed that the image forming apparatus 1 has such an auto copy function that the color type of an original document (monochrome original document or color original document) is automatically determined by the image reading unit 105, and in the case where the original document is the monochrome original document, the monochrome printing is performed, and in the case where the original document is the color original document, the color printing is performed.

The user first sets an original document to be copied on an original document stand or an ADF, and makes a desired print setting on the operation screen in the display unit 107.

For example, in the case where the user desires to perform the monochrome printing for one copy and the color printing for one copy, “the number of monochrome copies” and “the number of color copies” on the display of the screen shown in FIG. 2 are respectively set. When the number of monochrome copies and the number of color copies are set in this way, the column of “the number of auto copies” is displayed in gray (so-called gray out) and can not be selected.

On the other hand, when “the number of auto copies” is set, the columns of “the number of monochrome copies” and “the number of color copies” are displayed in gray and can not be selected.

Next, when the user depresses the “start key”, the copy processing of the original document is started. First, the first page of the color original document is scanned by the image reading unit 105, and a monochrome image and a color image are read at the same time. Next, the read monochrome image is transmitted to the first image processing unit 108, the read color image is transmitted to the second image processing unit 109, and the image processings are respectively performed.

When the image processings are completed, the respective image processing units store data created by the image processings into a storage area of, for example, the MEMORY 802. This is because in the image formation unit 106, only one of the monochrome printing and the color printing is executed at a time, and a buffer effect to absorb a difference between a scanning speed and a printing speed is made to be provided.

The print execution unit 104 repeats the series of processings as stated above to the last page of the original document, and as soon as the image processing for the monochrome printing is completed (as soon as at least the first page of the monochrome printing becomes printable), the print execution units reads the monochrome image data from the first page from the MEMORY 802, and prints it by the image formation unit 106.

When the number of prints of the monochrome image data reaches the number of monochrome copies which is set as stated above, the print execution unit 104 ends the monochrome printing. Next, the print execution unit 104 reads the color image data from the first page from the MEMORY 802, and prints it by the image formation unit 106.

In this way, when the number of prints of the color image data reaches the number of color copies which is set as described above, the color printing processing is ended. At this point, the monochrome copying and the color copying are completed.

As stated above, the image forming apparatus 1 of this embodiment uses the CCD sensor capable of reading both the monochrome image of the monochrome printing mode and the color image of the color printing mode at the same time, and the image processing unit capable of performing the image processings for the monochrome printing and the color printing at the same time. By this, two kinds of processings of the reading of the color image data by the scanning of the color original document in the color printing mode and the reading of the monochrome image data by the scanning in the monochrome printing mode can be executed at the same time by single scanning.

In the case of a structure including a scanner (image reading unit) 902 using a three-line CCD sensor 903 to read RGB color in the related art, in order to read an original document in two ways of monochrome and color, the original document must be scanned twice. However, when the structure of the image reading unit 105 of the image forming apparatus 1 according to this embodiment is adopted, the image reading of an original document in monochrome and color can be performed only by single scanning. Besides, when the structure in which the image readings for the monochrome printing and the color printing are performed only by the single scanning is adopted, a contribution can be made to the elongation of life of a drive mechanism of a scanning optical system.

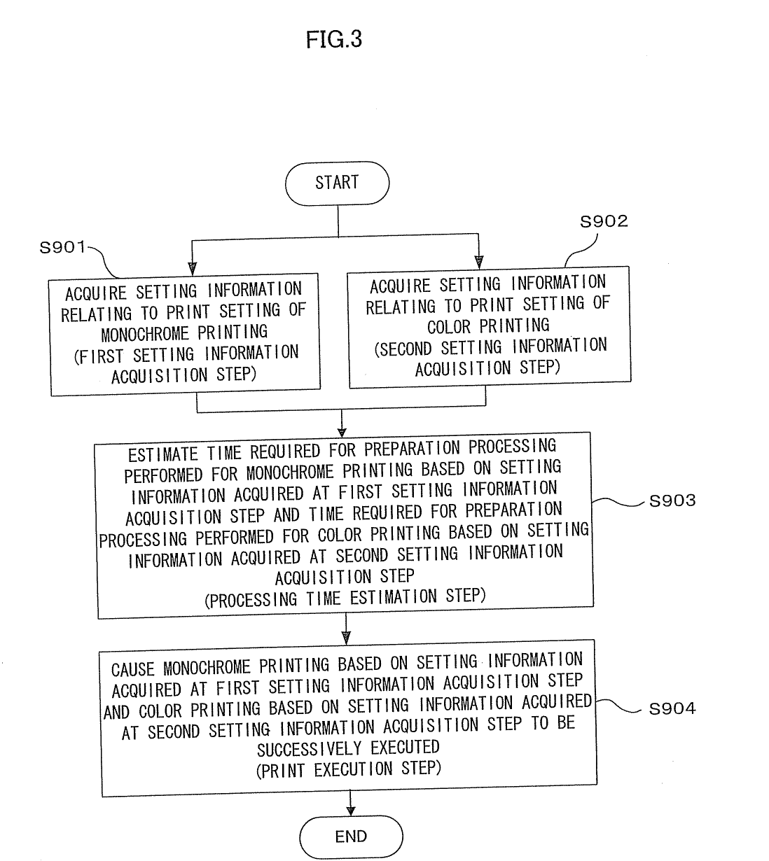

FIG. 3 is a flowchart for explaining a rough flow of a processing (image forming method) in the image forming apparatus 1 according to this embodiment.

The first setting information acquisition unit 101 acquires setting information relating to a print setting of monochrome printing (first setting information acquisition step) (S901).

The second setting information acquisition unit 102 acquires setting information relating to a print setting of color printing (second setting information acquisition step) (S902).

The processing time estimation unit 103 estimates a time required for a preparation processing performed for the monochrome printing based on the setting information acquired at the first setting information acquisition step, and a time required for a preparation processing performed for the color printing based on the setting information acquired at the second setting information acquisition step (processing time estimation step) (S903).

The print execution unit 104 causes the monochrome printing based on the setting information acquired at the first setting information acquisition step and the color printing based on the setting information acquired at the second setting information acquisition step to be successively executed (print execution step) (S904).

Incidentally, at the print execution step, it is preferable that the monochrome printing and the color printing are successively executed from one of them in which the time estimated at the processing time estimation step is shorter.

In addition, at the print execution step, the monochrome printing based on the setting information acquired at the first setting information acquisition step can be executed earlier than the color printing based on the setting information acquired at the second setting information acquisition step. Besides, at the print execution step, when the setting resolution acquired at the second setting information acquisition step is higher than the setting resolution acquired at the first setting information acquisition step, the monochrome printing may be executed earlier than the color printing. Besides, at the print execution step, when the setting gradation number acquired at the second setting information acquisition step is larger than the setting gradation number acquired at the first setting information acquisition step, the monochrome printing can be executed earlier than the color printing.

The respective steps of the processing in the image forming apparatus are realized by causing the CPU 801 to execute an image forming program stored in the MEMORY 802.

In this embodiment, although the description has been made on the case where the function to carry out the invention is previously recorded in the inside of the apparatus, no limitation is made to this, and a similar function may be downloaded from a network to the apparatus, or a similar function recorded on a recording medium may be installed in the apparatus. As the recording medium, any form may be adopted as long as the recording medium, such as a CD-ROM, can store the program and can be read by the apparatus. Besides, the function obtained by the previous installation or download may realize the function by cooperation with an OS (Operating System) of the inside of the apparatus.

Incidentally, in the embodiment, although the example in which the structure of the invention is applied to the image forming apparatus has been described, no limitation is made to this, and for example, an external equipment, such as a PC, connected to be capable of communicating with the image forming apparatus 1 may include the first setting information acquisition unit 101, the second setting information acquisition unit 102, the processing time estimation unit 103, and the print execution unit 104. In this case, in the case where print setting is caused by the direct operation input of the user to the image forming apparatus 1 and to the control panel or the like, the first setting information acquisition unit 101 and the second setting information acquisition unit 102 acquire the information relating to the print setting from the image forming apparatus 1, and in the case where the print operation is caused by the instruction from the printer driver or the like in the PC, the information relating to the print setting is acquired from the instruction content.

As described above, according to the embodiment, in the case where the monochrome printing and the color printing are desired to be performed, it is not necessary to individually perform the print setting operation for the monochrome printing and the print setting operation for the color printing, and the print settings are collectively performed, so that a contribution can be made to the reduction of work load. Incidentally, in the case where there are many same setting contents in the print setting for the monochrome printing and the print setting for the color printing (or the print settings are completely the same), the setting contents of one of the print settings may be used for the other print setting.

As stated above, the print setting work for the monochrome printing and the print setting work for the color printing are made to be capable of being collectively performed at a time, and therefore, it becomes possible to suppress the occurrence of a setting miss at the time of print setting work.

Although the invention has been described in detail on the specific mode, it would be apparent for one of ordinary skill in the art that various modifications and improvements can be made without departing from the sprit and scope of the invention.

As described above in detail, according to the invention, in the image forming apparatus capable of executing both the monochrome printing and the color printing, the technique to improve the work efficiency in the image formation processing can be provided.

What is claimed is:

1. An image forming apparatus comprising:
a first setting information acquisition unit configured to acquire setting information relating to a print setting of monochrome printing;
a second setting information acquisition unit configured to acquire setting information relating to a print setting of color printing; and
a print execution unit configured to cause the monochrome printing based on the setting information acquired by the first setting information acquisition unit and the color printing based on the setting information acquired by the second setting information acquisition unit to be successively executed.

2. The image forming apparatus according to claim 1, further comprising a processing time estimation unit configured to estimate a time required for a preparation processing performed for the monochrome printing based on the setting information acquired by the first setting information acquisition unit and a time required for a preparation processing performed for the color printing based on the setting information acquired by the second setting information acquisition unit,
wherein the print execution unit causes the monochrome printing and the color printing to be successively executed from one of them in which the time estimated by the processing time estimation unit is shorter.

3. The image forming apparatus according to claim 1, wherein the print execution unit causes the monochrome printing based on the setting information acquired by the first setting information acquisition unit to be executed earlier than the color printing based on the setting information acquired by the second setting information acquisition unit.

4. The image forming apparatus according to claim 1, wherein the print execution unit causes the monochrome printing to be executed earlier than the color printing when setting resolution acquired by the second setting information acquisition unit is higher than setting resolution acquired by the first setting information acquisition unit.

5. The image forming apparatus according to claim 1, wherein the print execution unit causes the monochrome printing to be executed earlier than the color printing when setting gradation number acquired by the second setting information acquisition unit is larger than setting gradation number acquired by the first setting information acquisition unit.

6. An image forming apparatus comprising:
first setting information acquisition means for acquiring setting information relating to a print setting of monochrome printing;
second setting information acquisition means for acquiring setting information relating to a print setting of color printing; and
print execution means for causing the monochrome printing based on the setting information acquired by the first setting information acquisition means and the color printing based on the setting information acquired by the second setting information acquisition means to be successively executed.

7. The image forming apparatus according to claim 6, further comprising processing time estimation means for estimating a time required for a preparation processing performed for the monochrome printing based on the setting information acquired by the first setting information acquisition means and a time required for a preparation processing performed for the color printing based on the setting information acquired by the second setting information acquisition means,
wherein the print execution means causes the monochrome printing and the color printing to be successively executed from one of them in which the time estimated by the processing time estimation means is shorter.

8. The image forming apparatus according to claim 6, wherein the print execution means causes the monochrome printing based on the setting information acquired by the first setting information acquisition means to be executed earlier than the color printing based on the setting information acquired by the second setting information acquisition means.

9. The image forming apparatus according to claim 6, wherein the print execution means causes the monochrome printing to be executed earlier than the color printing when setting resolution acquired by the second setting information acquisition means is higher than setting resolution acquired by the first setting information acquisition means.

10. The image forming apparatus according to claim 6, wherein the print execution means causes the monochrome printing to be executed earlier than the color printing when setting gradation number acquired by the second setting information acquisition means is larger than setting gradation number acquired by the first setting information acquisition means.

11. An image forming method comprising the steps of:
acquiring first setting information relating to a print setting of monochrome printing;
acquiring second setting information relating to a print setting of color printing; and
causing the monochrome printing based on the setting information acquired at the step of acquiring the first setting information and the color printing based on the setting information acquired at the step of acquiring the second setting information to be successively executed.

12. The image forming method according to claim 11, further comprising a step of estimating a time required for a preparation processing performed for the monochrome printing based on the setting information acquired at the step of acquiring the first setting information and a time required for a preparation processing performed for the color printing based on the setting information acquired at the step of acquiring the second setting information,
wherein at the step of causing the printing, the monochrome printing and the color printing are successively executed from one of them in which the time estimated at the step of estimating the time is shorter.

13. The image forming method according to claim 11, wherein at the step of causing the printing, the monochrome printing based on the setting information acquired at the step of acquiring the first setting information is executed earlier than the color printing based on the setting information acquired at the step of acquiring the second setting information.

14. The image forming method according to claim 11, wherein at the step of causing the printing, the monochrome printing is executed earlier than the color printing when setting resolution acquired at the step of acquiring the second setting information is higher than setting resolution acquired at the step of acquiring the first setting information.

15. The image forming method according to claim 11, wherein at the step of causing the printing, the monochrome printing is executed earlier than the color printing when setting gradation number acquired at the step of acquiring the second setting information is larger than setting gradation number acquired at the step of acquiring the first setting information.
